(19) United States
(12) Patent Application Publication
(10) Pub. No.: US 2023/0178100 A1
(43) Pub. Date: Jun. 8, 2023

(54) TAIL POINT DETECTION METHOD, ELECTRONIC DEVICE, AND NON-TRANSITORY COMPUTER-READABLE STORAGE MEDIUM

(71) Applicant: Beijing Baidu Netcom Science Technology Co., Ltd., Beijing (CN)

(72) Inventors: Chunming DU, Beijing (CN); Yongle WANG, Beijing (CN); Lifeng ZHAO, Beijing (CN); Dan WANG, Beijing (CN); Qiang CHENG, Beijing (CN); Mushui XU, Beijing (CN); Pengwei LI, Beijing (CN)

(21) Appl. No.: 18/074,681

(22) Filed: Dec. 5, 2022

(30) Foreign Application Priority Data
Dec. 6, 2021 (CN) 202111480838.1

(51) Int. Cl. G10L 25/87; G10L 25/93

(52) U.S. Cl. CPC G10L 25/87; G10L 25/93

(57) ABSTRACT

Provided are a tail point detection method and apparatus, a device, and a storage medium. The implementation scheme includes acquiring a target audio; identifying a sentence pattern type of the target audio; determining detection waiting duration according to the sentence pattern type; and determining a result of detecting a tail point of the target audio according to the detection waiting duration.

### CROSS-REFERENCE TO RELATED APPLICATION(S)

This application claims priority from Chinese Patent Application No. 202111480838.1 filed Dec. 6, 2021, the disclosure of which is incorporated herein by reference in its entirety.

### TECHNICAL FIELD

The present disclosure relates to the field of artificial intelligence technologies, in particular, to the field of speech recognition technologies and for example, to a tail point detection method, an electronic device, and a non-transitory computer-readable storage medium.

### BACKGROUND

With the rapid development of artificial intelligence technologies, speech recognition technology, as a key technology of a human-computer communication interface, has become increasingly important. Speech recognition includes a speech endpoint detection which is to find a start point and a tail point of a speech in continuous audio data. The speech endpoint detection is an important part of the speech recognition, and the accuracy of the speech endpoint detection affects the accuracy of the speech recognition.

### SUMMARY

The present disclosure provides a tail point detection method and apparatus, an electronic device, and a non-transitory computer-readable storage medium.

According to an embodiment of the present disclosure, a tail point detection method is provided and includes the following steps: a target audio is acquired; a sentence pattern type of the target audio is identified; detection waiting duration is determined according to the sentence pattern type; and a result of detecting a tail point of the target audio is determined according to the detection waiting duration.

According to an embodiment of the present disclosure, an electronic device is further provided and includes at least one processor and a memory communicatively connected to the at least one processor.

The memory stores instructions executable by the at least one processor to cause the at least one processor to perform: acquiring a target audio; identifying a sentence pattern type of the target audio; determining detection waiting duration according to the sentence pattern type; and determining a result of detecting a tail point of the target audio according to the detection waiting duration.

According to an embodiment of the present disclosure, a non-transitory computer-readable storage medium is further provided. The storage medium stores computer instructions for causing a computer to perform: acquiring a target audio; identifying a sentence pattern type of the target audio; determining detection waiting duration according to the sentence pattern type; and determining a result of detecting a tail point of the target audio according to the detection waiting duration.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a flowchart of a tail point detection method according to an embodiment of the present disclosure;

FIG. 2 is a flowchart of another tail point detection method according to an embodiment of the present disclosure;

FIG. 3 is a flowchart of another tail point detection method according to an embodiment of the present disclosure;

FIG. 4 is a flowchart of another tail point detection method according to an embodiment of the present disclosure;

FIG. 5 is a structural diagram of a tail point detection apparatus according to an embodiment of the present disclosure; and

FIG. 6 is a block diagram of an electronic device for implementing a tail point detection method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are illustrative only. Therefore, it will be appreciated by those having ordinary skill in the art that various changes and modifications may be made to the embodiments described herein without departing from the scope and spirit of the present disclosure. Similarly, description of well-known functions and constructions is omitted hereinafter for clarity and conciseness.

Each tail point detection method and tail point detection apparatus provided in the present disclosure are suitable for the case of tail point detection in a human-computer interaction process. Each tail point detection method provided in the present disclosure may be performed by the tail point detection apparatus. The apparatus may be implemented in software and/or hardware and is configured in an electronic device, and the electronic device may be a voice device, for example, in an intelligent loudspeaker, a car terminal, or the like.

For ease of understanding, each tail point detection method provided in the present disclosure is first described in detail.

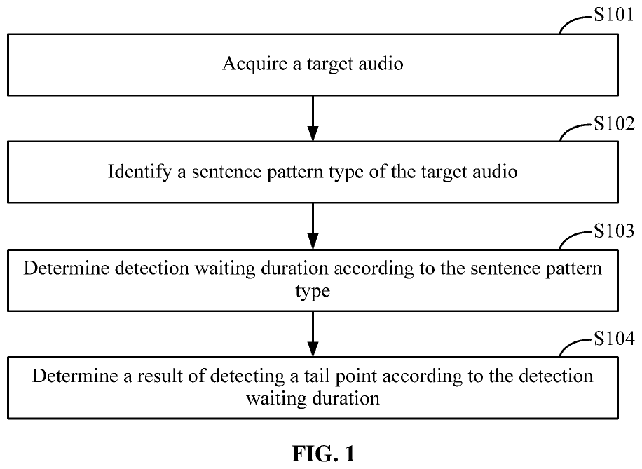

Referring to FIG. 1, a tail point detection method includes steps described below.

In S101, a target audio is acquired.

The target audio may be obtained in real time; or in a usage scenario with abundant time, the target audio may also be pre-recorded and stored locally.

In some implementations, an initiator of the target audio may send a speech instruction to an electronic device performing the tail point detection method, and after receiving the speech instruction, the electronic device may store the speech instruction as the target audio.

In S102, a sentence pattern type of the target audio is identified.

The sentence pattern types are used for representing different categories, sequences and collocations of words that make up the sentence. For example, the sentence pattern types may be divided into subject-verb-object sentences, non-subject-verb sentences, passive voice sentences, inverted sentences, pivotal sentences, sentences with serial verbs and the like, and the sentence pattern type may also be customized.

In an embodiment, a semantic analysis technology may be used for identifying the sentence pattern type of the target audio. The semantic analysis technology may be implemented by any technology that supports a semantic analysis in the related art, which is not limited in the present disclosure.

In S103, detection waiting duration is determined according to the sentence pattern type.

In an embodiment, the corresponding detection waiting duration may be determined in advance according to the sentence pattern type. For example, a detection waiting duration may be provided correspondingly for each sentence pattern type. After the sentence pattern type of the target audio is identified, the corresponding detection waiting duration may be determined according to the sentence pattern type.

In an embodiment, for the convenience of implementation, the sentence pattern types may be classified into categories in advance, and different detection waiting durations may be provided correspondingly for different classification results. The present disclosure does not make any limitation on the classification manner of the sentence pattern types.

For example, the sentence pattern types may be classified into categories according to response speed requirements, and the classified categories include five categories: T1, T2, T3, T4 and T5, where T1, T2, T3, T4 and T5 may correspond to detection waiting durations sequentially increasing from small to large.

In S104, a result of detecting a tail point is determined according to the detection waiting duration.

In an embodiment, after the detection waiting duration, the result of detecting the tail point is determined, so as to avoid the occurrence of misrecognizing a normal short pause in the target audio as a voice tail point, thereby improving the accuracy of the result of detecting the tail point. The result of detecting the tail point is usually an important and critical step in other speech signal processing such as speech recognition, which is conducive to improving the accuracy of subsequent speech recognition and the like.

In the embodiments of the present disclosure, the detection waiting duration can be adjusted according to the sentence pattern type, instead of uniformly setting a fixed detection waiting duration. In this manner, the flexibility of the tail point detection timing in a human-computer voice interaction process is improved, a problem of low efficiency caused by an excessively long waiting duration for the tail point detection is solved, and the occurrence of misrecognizing a normal short pause as a voice tail point is avoided, which is conducive to improving the accuracy of the result of detecting the tail point.

The present disclosure further provides an embodiment based on the preceding various technical scheme. In this embodiment, a process of determining the detection waiting duration is optimized and improved. It is to be noted that, for the part that is not described in detail in the embodiment of the present disclosure, reference may be made to the relevant descriptions of the preceding embodiments, which is not repeated here.

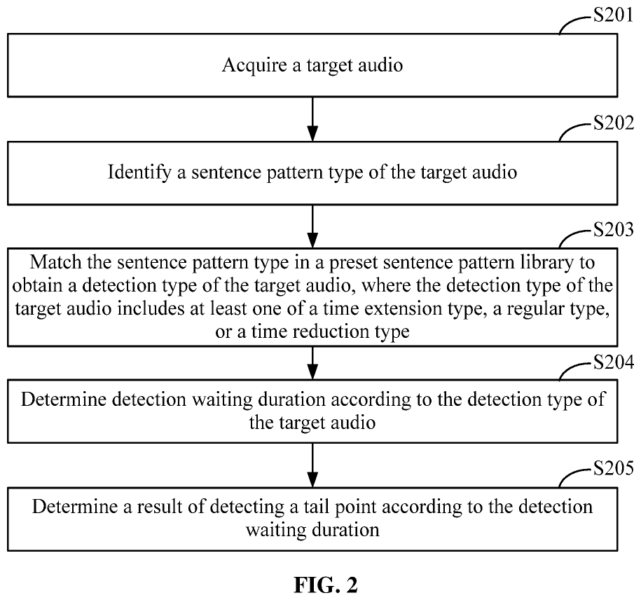

Referring to FIG. 2, a tail point detection method includes steps described below.

In S201, a target audio is acquired.

In S202, a sentence pattern type of the target audio is identified.

In S203, the sentence pattern type is matched in a preset sentence pattern library to obtain a detection type, where the detection type includes at least one of a time extension type, a regular type, or a time reduction type.

The preset sentence pattern library may include at least one standard sentence pattern. In the matching process, the sentence pattern type may be sequentially matched with each standard sentence pattern in the preset sentence pattern library; and the detection type of the target audio is determined according to a category corresponding to the matched standard sentence pattern.

To facilitate the implementation, the detection types may be classified into three types: a time extension type, a regular type, and a time reduction type. Different detection waiting durations may be provided correspondingly for different detection types.

By way of example, a detection type corresponding to a sentence pattern type including an explicitly specified object may be configured to be the time reduction type. For example, the explicitly specified objects of “a previous piece” or “a next piece” when music is played are “a previous piece of music” or “a next piece of music” of the currently played music in a music playlist. For another example, the explicitly specified object of “turn on the air conditioner” when the vehicle is running is the “air conditioner”.

By way of example, a detection type corresponding to a sentence pattern type including a customized specified object may be configured to be the time extension type. For example, when a call is made, the customized specified object of “dial to 137XXXXXXXX” is “137XXXXXXXX”. For another example, the customized specified object of “play the YY-th episode of the XXX TV series” when a video is played is “the YY-th episode of the XXX TV series”.

By way of example, detection types corresponding to other sentence pattern types other than those that include explicitly specified objects or customized specified objects may be configured to be regular types.

In S204, detection waiting duration is determined according to the detection type.

Generally, a t_{time reduction type} with a relatively short detection waiting duration may be set for the target audio whose detection type is the time reduction type; a t_{regular type} with a normal detection waiting duration may be set for the target audio whose detection type is the regular type; and a t_{time extension type} with a relatively long detection waiting duration may be set for the target audio whose detection type is the time extension type; where t_{time reduction type}<t_{regular type}<t_{time extension type}. Specific duration values of the t_{time reduction type}, the t_{regular type} and the t_{time extension type} may be determined according to the actual use requirements and conditions. For example, different detection waiting durations may be provided correspondingly for different service scenarios.

In an embodiment, to determine the detection waiting duration more reasonably, the detection waiting duration may be dynamically adjusted in conjunction with features such as a speech rate and/or intonation of the initiator of the target audio. In an embodiment, in the case where the speech rate of the initiator of the target audio is relatively slow, the detection waiting duration corresponding to each detection type may be configured to increase in ratio or in value; and in the case where the speech rate of the initiator of the target audio is relatively fast, the detection waiting duration corresponding to each detection type is configured to decrease in ratio or in value; where the specific set increased ratio or value or the specific set decreased ratio or value may be determined according to empirical values or experimental values.

It is to be noted that it is also feasible to choose to adjust or not to adjust the detection waiting duration corresponding to each detection type according to the actual use requirements and conditions. For example, only the detection waiting duration corresponding to the time extension type may be dynamically adjusted, so as to avoid adjustment of other detection types, resulting in a decrease in accuracy or prolonged waiting.

In S205, a result of detecting a tail point is determined according to the detection waiting duration.

Based on the preceding technical schemes, the sentence pattern types corresponding to different detection types in the preset sentence pattern library may also be updated or adjusted.

In an embodiment, the preset sentence pattern library also supports additions, deletions, changes, and inquiries by the operation and maintenance personnel, so as to achieve flexible adjustment of the sentence pattern types corresponding to different detection types in the preset sentence pattern library. In this manner, the preset sentence pattern library continuously adapts to specific voice services.

Alternatively, in an embodiment, the content in the preset sentence pattern library may be dynamically adjusted in an automated manner. By way of example, a response failure frequency of a speech instruction corresponding to a historical audio may be acquired; a detection type of a sentence pattern type corresponding to the speech instruction in the preset sentence pattern library is adjusted according to the response failure frequency.

The response failure frequency may be determined in the following manners: during the testing or use process of the electronic device, a test initiator may send a speech instruction to the electronic device according to a test task to acquire a response result of the electronic device to the speech instruction, and the response failure frequency may be generated according to the response result; or during a service process of the electronic device, the response failure frequency of the speech instruction corresponding to the historical audio of the initiator of the target audio may be collected and counted.

Generally, if the response failure frequency exceeds a set frequency threshold, the detection type of the sentence pattern type corresponding to the speech instruction in the preset sentence pattern library may be adjusted according to a response failure result. The set frequency threshold may be determined according to empirical values.

For example, in the case where the response failure result shows that the waiting duration is too long (for example, the initiator responds manually before an automatic response), the detection type of the sentence pattern type corresponding to the speech instruction in the preset sentence pattern library may be adjusted to a detection type with a relatively short detection waiting duration.

It is to be understood that, according to the response failure frequency, the detection type of the sentence pattern type corresponding to the speech instruction in the preset sentence pattern library may be adjusted, thereby playing a role of optimizing the preset sentence pattern library, which is conducive to improving a matching degree between the detection types corresponding to different sentence pattern types in the preset sentence pattern library and the initiator of the speech instruction.

In the embodiment of the present disclosure, the sentence pattern type of the target audio is matched in the preset sentence pattern library to obtain the detection type, where the detection type includes at least one of the time extension type, the regular type, or the time reduction type; and the detection waiting duration is determined according to the detection type. In the preceding technical scheme, the preset sentence pattern library including different sentence pattern types of different detection types is introduced so as to determine the detection type corresponding to the target audio, and the same detection waiting duration is set for the same detection type so as to avoid the increase in calculation and storage capacity caused by the excessive detection waiting duration, which is convenient for the management and maintenance of the detection waiting duration. At the same time, the detection waiting duration is determined by type matching so that the determination manner is simple and convenient, and the efficiency of determining the detection waiting duration is improved.

Based on the preceding technical schemes, the present disclosure further provides an embodiment. In this embodiment, if the detection type is the time extension type, environment data of the target audio and a speech rate feature of an initiator of the target audio are introduced so that a process of determining the detection waiting duration is optimized and improved.

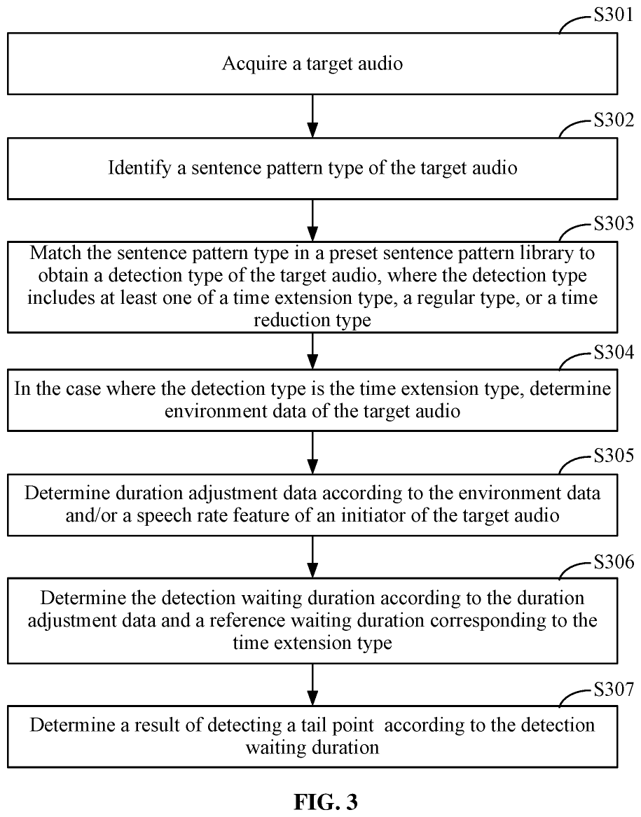

Referring to FIG. 3, a tail point detection method includes steps described below.

In S301, a target audio is acquired.

In S302, a sentence pattern type of the target audio is identified.

In S303, the sentence pattern type is matched in a preset sentence pattern library to obtain a detection type, where the detection type includes at least one of a time extension type, a regular type, or a time reduction type.

In S304, if the detection type is the time extension type, environment data of the target audio is determined.

The environment data of the target audio includes but is not limited to emotion data of the initiator of the target audio, voice usage habit data of the initiator of the target audio, language type data of the initiator of the target audio, and data about a scene where the initiator of the target audio is located and time.

Generally, in the case where the emotion of the initiator of the target audio is happiness, the intonation is high and the speech rate is relatively fast; and in the case where the emotion of the initiator of the target audio is distress, the intonation is low and the speech rate is slow. Therefore, the emotion of the initiator of the target audio may be identified, and the speech rate of the initiator of the target audio is indirectly determined according to an emotion identification result so that the detection waiting duration may be determined according to the speech rate.

In an embodiment, considering that the initiator of the target audio may perform voice interaction on other electronic devices, an image or video stream containing a human face may be collected by a camera or a video camera on the electronic device, face recognition is performed on the initiator of the target audio, and a correspondence between the initiator of the target audio and the voice usage habit is established and stored in a background server of the electronic device. When the initiator of the target audio outputs a speech instruction on the electronic device, face recognition may be performed on the initiator of the target audio first, and the voice usage habit corresponding to the initiator of the target audio is acquired from the background server of the electronic device through a face identification result.

In an embodiment, emotion recognition is performed on the initiator of the target audio through the target audio or a historical audio of a historical time period associated with an initial moment of the target audio, thereby determining an emotion category of the initiator of the target audio.

In an embodiment, considering pronunciation characteristics of languages, the speeds of voice communication are different when the languages of different language types are used for communication. Therefore, a language type of the initiator of the target audio may be used as a factor affecting the detection waiting duration, thereby making the determination of the detection waiting duration more reasonable.

In an embodiment, it is considered that the scene where the initiator of the target audio is located and time also affect the detection waiting duration. For example, on the way to work, to save time, the initiator of the target audio may output a relatively fast speech instruction for voice interaction.

In an embodiment, according to the actual use requirements and conditions, the preceding environmental factors including the emotion of the initiator of the target audio, the voice usage habit of the initiator of the target audio, the language type of the initiator of the target audio, and the scene where the initiator of the target audio is located and time may be screened, the environmental factors that conform to a specific voice service type are selected, and the environment data of the target audio is acquired through a corresponding data collection method.

In S305, duration adjustment data is determined according to the environment data and/or a speech rate feature of an initiator of the target audio.

The duration adjustment data refers to data adjusted based on a reference waiting duration, and the duration adjustment data may be an adjustment ratio value or an adjustment value.

The reference waiting duration refers to an artificially preset waiting duration corresponding to the detection type, and different detection types may correspond to different reference waiting durations.

In some implementations, the duration adjustment data may be determined according to only the speech rate feature of the initiator of the target audio and directly according to the relatively slow speech rate of the initiator of the target audio; or the duration adjustment data is indirectly determined according to only the environment data and by means of coupling at least one environmental factor; or the duration adjustment data is determined by a comprehensive evaluation manner according to both the environment data and the speech rate feature of the initiator of the target audio.

In an embodiment, the duration adjustment data may be determined according to the environment data and the speech rate feature of the initiator of the target audio and based on a preset environmental factor weight and a preset personal speech rate weight. A sum of the preset environmental factor weight and the preset personal speech rate weight is 1, and the preset environmental factor weight and the preset personal speech rate weight may be the same or different.

Typically, for the convenience of implementation, the preset environmental factor weight and the preset personal speech rate weight may be set to same weights.

Preferably, to more visually reflect the influence of the speech rate on the duration adjustment data, the preset personal speech rate weight may be configured to be higher than the preset environmental factor weight.

In S306, the detection waiting duration is determined according to the duration adjustment data and a reference waiting duration corresponding to the time extension type.

In an embodiment, after the detection type of the target audio is determined, the corresponding reference waiting duration may be determined according to the detection type.

It is to be understood that, considering that the regular type and the time reduction type correspond to relatively short reference waiting durations, if the duration adjustment data continues to be determined and the reference waiting duration is adjusted through the duration adjustment data, the detection waiting duration is shorter, thereby possibly leading to errors or unreasonable situations. Therefore, here the detection waiting duration is adjusted only for the detection type of target audio being the time extension type.

In an embodiment, if the detection type is not the time extension type, the reference waiting duration corresponding to the detection type may be determined as the detection waiting duration directly according to the detection type.

It is to be noted that, in a process of determining the detection waiting duration, the reference waiting duration corresponding to the time extension type may be adjusted to be longer or shorter based on the duration adjustment data, but it needs to ensure that the adjusted detection waiting duration is less than the reference waiting duration corresponding to the regular type, thereby obtaining the detection waiting duration that conforms to the actual condition.

In S307, a result of detecting a tail point is determined according to the detection waiting duration.

In the embodiment of the present disclosure, in the case where the detection type is the time extension type, the duration adjustment data is determined according to the environment data and/or the speech rate feature of the initiator of the target audio, and the detection waiting duration is adjusted according to the duration adjustment data and the reference waiting duration corresponding to the time extension type, thereby optimizing the process of determining the detection waiting duration. A voice interaction environment is considered in the environment data so that the objectivity of the determination of the detection waiting duration is improved, and the detection waiting duration can adapt to the corresponding voice interaction environment; and the speech rate feature reflects the fast or slow speech rate of the initiator of the target audio and is directly related to the detection waiting duration. The speech rate feature is considered so that a matching degree between the detection waiting duration and the initiator of the target audio is improved. Through the preceding technical scheme, the determination of the detection waiting duration is more reasonable, thereby further improving the accuracy of the tail point detection result.

Based on the preceding technical schemes, the present disclosure further provides a preferred embodiment, in which the specific content of the environment data is described in detail in the preferred embodiment.

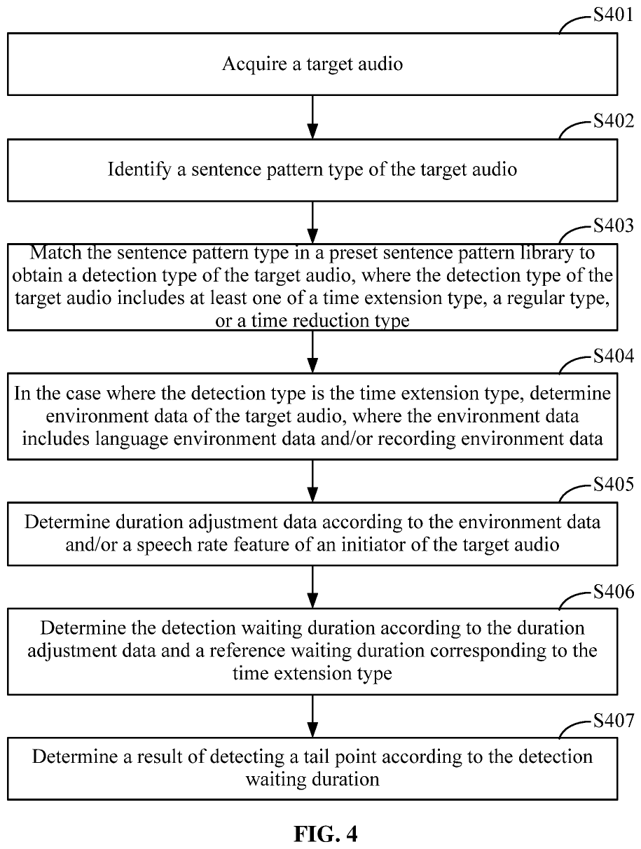

Referring to FIG. 4, a tail point detection method includes steps described below.

In S401, a target audio is acquired.

In S402, a sentence pattern type of the target audio is identified.

In S403, the sentence pattern type is matched with a preset sentence pattern library so as to obtain a detection type, where the detection type includes at least one of a time extension type, a regular type, or a time reduction type.

In S404, if the detection type is the time extension type, environment data of the target audio is determined, where the environment data includes language environment data and/or recording environment data.

In some implementations, to comprehensively determine the environment data of the target audio, the process of determining the environment data of the target audio may include determining the environment data of the target data according to the language environment data and the recording environment data by means of a weighted sum based on a preset language environment weight and a preset recording environment weight. A sum of the preset language environment weight and the preset recording environment weight is 1, and the preset language environment weight and the preset recording environment weight may be the same or different.

In an embodiment, the step of determining the language environment data of the target audio includes determining a language category of audio content in the target audio and an emotion category corresponding to the target audio, respectively; and generating the language environment data according to the language category and/or the emotion category.

In some implementations, the language category of the audio content in the target audio may be identified based on a set language identification model; and/or the emotion category corresponding to the target audio may be identified based on a set emotion identification model. The set language identification model may be implemented by any technology that supports language category identification in the related art, and the set emotion identification model may be implemented by any technology that supports emotion identification in the related art.

In an embodiment, according to the speech rate feature of the language, the language categories may be divided into three levels, including: L1 (fast), L2 (normal) and L3 (slow); and according to the lightness of the emotion, the emotion categories may be divided into three levels, including: E1 (light), E2 (normal) and E3 (heavy).

It is to be understood that the language category and the emotion category provide data support for the generation of the language environment data.

In some implementations, to comprehensively determine the language environment data, a process of determining the language environment data may include determining the language environment data according to the language category and the emotion category by means of a weighted sum based on a preset language category weight and a preset emotion category weight. A sum of the preset language category weight and the preset emotion category weight is 1, and the preset language category weight and the preset emotion category weight may be the same or different.

In another implementation, to simplify the calculation, an evaluation level of the language environment may also be generated according to the language category and the emotion category based on a level classification manner, and the evaluation level may be used as the language environment data.

In an embodiment, the step of determining the recording environment data of the target audio includes identifying a noise category in a recording environment where the target audio is located; identifying whether a recording region corresponding to the target audio is in a familiar road segment; identifying whether a recording moment corresponding to the target audio is in a familiar time period; and generating the recording environment data according to at least one of the noise category, a road segment identification result, or a time period identification result.

Since environment noise also affects the voice interaction of the initiator of the target audio, the noise in the recording environment where the target audio is located may be considered; and since the recording region and the recording moment corresponding to the target audio also affect the voice interaction of the initiator of the target audio, the noise in the recording environment where the target audio is located may also be considered so that the determined recording environment data is more abundant and comprehensive.

In some implementations, to comprehensively determine the recording environment data, a process of determining the recording environment data may include determining the recording environment data according to the noise category, the road segment identification result, and the time period identification result by means of a weighted sum based on a preset noise weight, a preset road segment weight, and a preset time period weight. A sum of the preset noise weight, the preset road segment weight and the preset time period weight is 1, the preset noise weight, the preset road segment weight and the preset time period weight may be the same or different, and the specific weights may be determined according to the actual use requirements and conditions.

It is to be understood that the noise category, the road segment identification result and the time period identification result provide data support for the generation of the recording environment data, thereby improving the richness of the recording environment data, which is conducive to improving a matching degree between a detection waiting duration determination result and the initiator of the speech instruction.

In S405, duration adjustment data is determined according to the environment data and/or a speech rate feature of an initiator of the target audio.

In S406, the detection waiting duration is determined according to the duration adjustment data and a reference waiting duration corresponding to the time extension type.

In S407, a result of detecting a tail point is determined according to the detection waiting duration.

According to the technology of the present disclosure, in the embodiments of the present disclosure, the specific content of the environment data is identified and classified, the environment data is divided into two types: the language environment data and the recording environment data, the environment data may be determined from multiple dimensions, and the multi-dimensional data analysis and intelligent decision-making are provided so that the accuracy of determining the duration adjustment data is improved, the detection waiting duration may be reasonably adjusted, and the process of determining the detection waiting duration corresponding to the time extension type is optimized.

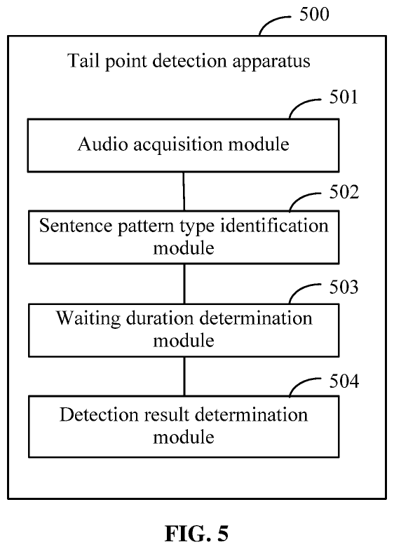

As the implementation of each of the preceding tail point detection methods, the present disclosure further provides an embodiment of an execution apparatus for performing the tail point detection method. Further referring to a tail point detection apparatus 500 shown in FIG. 5, the apparatus includes an audio acquisition module 501, a sentence pattern type identification module 502, a waiting duration determination module 503, and a detection result determination module 504.

The audio acquisition module 501 is configured to acquire a target audio.

The sentence pattern type identification module 502 is configured to identify a sentence pattern type of the target audio.

The waiting duration determination module 503 is configured to determine detection waiting duration according to the sentence pattern type.

The detection result determination module 504 is configured to determine a result of detecting a tail point according to the detection waiting duration.

In the embodiments of the present disclosure, the detection waiting duration can be adjusted according to the sentence pattern type, instead of uniformly setting a fixed detection waiting duration. In this manner, the flexibility of the tail point detection timing in a human-computer voice interaction process is improved, a problem of low efficiency caused by an excessively long waiting duration for the tail point detection is solved, and the occurrence of misrecognizing a normal short pause as a voice tail point is avoided, which is conducive to improving the accuracy of the tail point detection result.

In an embodiment, the waiting duration determination module 503 includes a matching unit and a waiting duration determination unit.

The matching unit is configured to match the sentence pattern type in a preset sentence pattern library to obtain a detection type, where the detection type includes at least one of a time extension type, a regular type, or a time reduction type.

The waiting duration determination unit is configured to determine the detection waiting duration according to the detection type.

In an embodiment, if the detection type is the time extension type, the waiting duration determination unit includes an environment data determination subunit, a duration adjustment subunit, and a waiting duration determination subunit.

The environment data determination subunit is configured to determine environment data of the target audio.

The duration adjustment subunit is configured to determine duration adjustment data according to the environment data and/or a speech rate feature of an initiator of the target audio.

The waiting duration determination subunit is configured to determine the detection waiting duration according to the duration adjustment data and a reference waiting duration corresponding to the time extension type.

In an embodiment, the environment data includes language environment data and/or recording environment data.

In an embodiment, the apparatus a language data determination subunit, where the language data determination subunit includes a category determination slave unit and a language data generation slave unit.

The category determination slave unit is configured to determine a language category of audio content in the target audio and an emotion category corresponding to the target audio, respectively.

The language data generation slave unit is configured to generate the language environment data according to the language category and/or the emotion category.

In an embodiment, the apparatus a recording data determination subunit, where the recording data determination subunit includes a category identification slave unit, a road segment identification slave unit, a time period identification slave unit, and a recording data generation slave unit.

The category identification slave unit is configured to identify a noise category in a recording environment where the target audio is located.

The road segment identification slave unit is configured to identify whether a recording region corresponding to the target audio is in a familiar road segment.

The time period identification slave unit is configured to identify whether a recording moment corresponding to the target audio is in a familiar time period.

The recording data generation slave unit is configured to generate the recording environment data according to at least one of the noise category, a road segment identification result, or a time period identification result.

In an embodiment, the apparatus further includes a failure frequency acquisition unit.

The failure frequency acquisition unit is configured to acquire a response failure frequency of a speech instruction corresponding to a historical audio.

The adjustment unit is configured to adjust a detection type of a sentence pattern type corresponding to the speech instruction in the preset sentence pattern library according to the response failure frequency.

The preceding tail point detection apparatus may perform the tail point detection method provided by any embodiment of the present disclosure and has function modules and beneficial effects corresponding to each performed tail point detection method.

In the technical schemes of the present disclosure, the collection, storage, use, processing, transmission, provision, and disclosure of the involved target audio, language environment data, recording environment data and the response failure frequency are in compliance with provisions of relevant laws and regulations and do not violate public order and good customs.

According to the embodiments of the present disclosure, the present disclosure further provides an electronic device, a readable storage medium, and a computer program product.

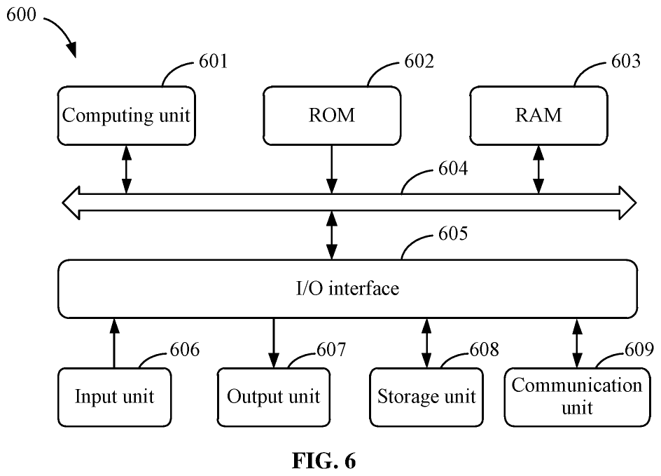

FIG. 6 is a block diagram of an exemplary electronic device 600 that may be configured to implement the embodiments of the present disclosure. Electronic devices are intended to represent various forms of digital computers, for example, a laptop computer, a desktop computer, a worktable, a personal digital assistant, a server, a blade server, a mainframe computer or another applicable computer. Electronic devices may further represent various forms of mobile apparatuses, for example, personal digital assistants, cellphones, smartphones, wearable devices, and other similar computing apparatuses. Herein the shown components, the connections and relationships between these components, and the functions of these components are illustrative only and are not intended to limit the implementation of the present disclosure as described and/or claimed herein.

As shown in FIG. 6, the device 600 includes a computing unit 601. The computing unit 601 may perform various types of appropriate operations and processing based on a computer program stored in a read-only memory (ROM) 602 or a computer program loaded from a storage unit 608 to a random-access memory (RAM) 603. Various programs and data required for operations of the device 600 may also be stored in the RAM 603. The computing unit 601, the ROM 602 and the RAM 603 are connected to each other through a bus 604. An input/output (I/O) interface 605 is also connected to the bus 604.

Multiple components in the device 600 are connected to the I/O interface 605. The components include an input unit 606 such as a keyboard and a mouse, an output unit 607 such as various types of displays and speakers, the storage unit 608 such as a magnetic disk and an optical disc, and a communication unit 609 such as a network card, a modem and a wireless communication transceiver. The communication unit 609 allows the device 600 to exchange information/data with other devices over a computer network such as the Internet and/or various telecommunications networks.

The computing unit 601 may be various general-purpose and/or special-purpose processing components having processing and computing capabilities. Examples of the computing unit 601 include, but are not limited to, a central processing unit (CPU), a graphics processing unit (GPU), a special-purpose artificial intelligence (AI) computing chip, a computing unit executing machine learning models and algorithms, a digital signal processor (DSP) and any appropriate processor, controller and microcontroller. The computing unit 601 performs various methods and processing described above, such as the tail point detection method. For example, in some embodiments, the tail point detection method may be implemented as a computer software program tangibly contained in a machine-readable medium such as the storage unit 608. In some embodiments, part or all of computer programs may be loaded and/or installed on the device 600 via the ROM 602 and/or the communication unit 609. When the computer program is loaded to the RAM 603 and executed by the computing unit 601, one or more steps of the preceding tail point detection method may be performed. Alternatively, in other embodiments, the computing unit 601 may be configured, in any other suitable manner (for example, by means of firmware), to perform the tail point detection method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting the data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed in whole on a machine, executed in part on a machine, executed, as a stand-alone software package, in part on a machine and in part on a remote machine, or executed in whole on a remote machine or a server.

In the context of the present disclosure, a machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical memory device, a magnetic memory device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is the study of making computers simulate certain human thinking processes and intelligent behaviors (such as learning, reasoning, thinking and planning) both at the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

According to an embodiment of the present disclosure, the present disclosure further provides a vehicle, where the vehicle is provided with the electronic device provided in any embodiment of the present disclosure.

It is to be understood that various forms of the preceding flows may be used with steps reordered, added, or removed. For example, the steps described in the present disclosure may be executed in parallel, in sequence or in a different order as long as the desired result of the technical solutions disclosed in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A tail point detection method, comprising:
acquiring a target audio;
identifying a sentence pattern type of the target audio;
determining detection waiting duration according to the sentence pattern type; and
determining a result of detecting a tail point of the target audio according to the detection waiting duration.

2. The method of claim 1, wherein determining the detection waiting duration according to the sentence pattern type comprises:
matching the sentence pattern type in a preset sentence pattern library to obtain a detection type of the target audio, wherein the detection type of the target audio comprises at least one of a time extension type, a regular type, or a time reduction type; and
determining the detection waiting duration according to the detection type of the target audio.

3. The method of claim 2, wherein in a case where the detection type of the target audio is the time extension type, determining the detection waiting duration according to the detection type of the target audio comprises:
determining environment data of the target audio;
determining duration adjustment data according to at least one of the environment data or a speech rate feature of an initiator of the target audio; and
determining the detection waiting duration according to the duration adjustment data and a reference waiting duration corresponding to the time extension type.

4. The method of claim 3, wherein the environment data comprises at least one of language environment data or recording environment data.

5. The method of claim 4, wherein in a case where the environment data is the language environment data, determining the environment data of the target audio comprises:
determining a language category of audio content in the target audio and an emotion category corresponding to the target audio, respectively; and
generating the language environment data according to at least one of the language category or the emotion category.

6. The method of claim 4, wherein in a case where the environment data is the recording environment data, determining the environment data of the target audio comprises:
identifying a noise category in a recording environment where the target audio is located;
identifying whether a recording region corresponding to the target audio is in a familiar road segment;
identifying whether a recording moment corresponding to the target audio is in a familiar time period; and
generating the recording environment data according to at least one of the noise category, a road segment identification result, or a time period identification result.

7. The method of claim 2, further comprising:
acquiring a response failure frequency of a speech instruction corresponding to a historical audio; and
adjusting a detection type of a sentence pattern type corresponding to the speech instruction in the preset sentence pattern library according to the response failure frequency.

8. The method of claim 3, further comprising:
acquiring a response failure frequency of a speech instruction corresponding to a historical audio; and
adjusting a detection type of a sentence pattern type corresponding to the speech instruction in the preset sentence pattern library according to the response failure frequency.

9. The method of claim 4, further comprising:
acquiring a response failure frequency of a speech instruction corresponding to a historical audio; and
adjusting a detection type of a sentence pattern type corresponding to the speech instruction in the preset sentence pattern library according to the response failure frequency.

10. The method of claim 5, further comprising:
acquiring a response failure frequency of a speech instruction corresponding to a historical audio; and
adjusting a detection type of a sentence pattern type corresponding to the speech instruction in the preset sentence pattern library according to the response failure frequency.

11. The method of claim 6, further comprising:
acquiring a response failure frequency of a speech instruction corresponding to a historical audio; and
adjusting a detection type of a sentence pattern type corresponding to the speech instruction in the preset sentence pattern library according to the response failure frequency.

12. An electronic device, comprising:
at least one processor; and
a memory communicatively connected to the at least one processor;
wherein the memory stores instructions executable by the at least one processor, wherein the instructions, when executed by the at least one processor, cause the at least one processor to perform:
acquiring a target audio;
identifying a sentence pattern type of the target audio;
determining detection waiting duration according to the sentence pattern type; and
determining a result of detecting a tail point of the target audio according to the detection waiting duration.

13. The electronic device of claim 12, wherein the instructions, when executed by the at least one processor, cause the at least one processor to perform determining the detection waiting duration according to the sentence pattern type in the following way:
matching the sentence pattern type in a preset sentence pattern library to obtain a detection type of the target audio, wherein the detection type of the target audio comprises at least one of a time extension type, a regular type, or a time reduction type; and
determining the detection waiting duration according to the detection type of the target audio.

14. The electronic device of claim 13, wherein in a case where the detection type of the target audio is the time extension type, the instructions, when executed by the at least one processor, cause the at least one processor to perform determining the detection waiting duration according to the detection type of the target audio in the following way:
determining environment data of the target audio;
determining duration adjustment data according to at least one of the environment data or a speech rate feature of an initiator of the target audio; and
determining the detection waiting duration according to the duration adjustment data and a reference waiting duration corresponding to the time extension type.

15. The electronic device of claim 14, wherein the environment data comprises at least one of language environment data or recording environment data.

16. The electronic device of claim 15, wherein in a case where the environment data is the language environment data, the instructions, when executed by the at least one processor, cause the at least one processor to perform determining the environment data of the target audio in the following way:
determining a language category of audio content in the target audio and an emotion category corresponding to the target audio, respectively; and
generating the language environment data according to at least one of the language category or the emotion category.

17. The electronic device of claim 15, wherein in a case where the environment data is the recording environment data, the instructions, when executed by the at least one processor, cause the at least one processor to perform determining the environment data of the target audio in the following way:
identifying a noise category in a recording environment where the target audio is located;
identifying whether a recording region corresponding to the target audio is in a familiar road segment;
identifying whether a recording moment corresponding to the target audio is in a familiar time period; and
generating the recording environment data according to at least one of the noise category, a road segment identification result, or a time period identification result.

18. The electronic device of claim 13, wherein the instructions, when executed by the at least one processor, cause the at least one processor to further perform:
acquiring a response failure frequency of a speech instruction corresponding to a historical audio; and
adjusting a detection type of a sentence pattern type corresponding to the speech instruction in the preset sentence pattern library according to the response failure frequency.

19. The electronic device of claim 14, wherein the instructions, when executed by the at least one processor, cause the at least one processor to further perform:
acquiring a response failure frequency of a speech instruction corresponding to a historical audio; and
adjusting a detection type of a sentence pattern type corresponding to the speech instruction in the preset sentence pattern library according to the response failure frequency.

20. A non-transitory computer-readable storage medium storing computer instructions for causing a computer to perform:
acquiring a target audio;
identifying a sentence pattern type of the target audio;
determining detection waiting duration according to the sentence pattern type; and
determining a result of detecting a tail point of the target audio according to the detection waiting duration.
